(19) United States
(12) Patent Application Publication
(10) Pub. No.: US 2009/0322967 A1
(43) Pub. Date: Dec. 31, 2009

(54) Notebook computer having projection function

(75) Inventors: Guan-De Liou, Taipei City (TW); Stephen Tsai, Sijhih City (TW); Li-Li Lai, Taipei City (TW); Shau-Yu Huang, Taipei City (TW)

Correspondence Address: BACON & THOMAS, PLLC, 625 SLATERS LANE, FOURTH FLOOR, ALEXANDRIA, VA, 22314-1176, US

(73) Assignee: Hannspree, Inc., Taipei City (TW)

(21) Appl. No.: 12/382,575

(22) Filed: Mar. 19, 2009

(30) Foreign Application Priority Data
Jun. 26, 2008 (TW) 097123902

(51) Int. Cl. H04N 9/31

(52) U.S. Cl. 348/744

(57) ABSTRACT

A notebook computer having projection function includes a mainframe, a display, and a compact projector. The compact projector is pivotally disposed at the upper portion of a frame area, and is electrically connected with the mainframe so as to receive signals therefrom. The compact projector projects images identical to those shown from the display toward a direction opposite to a displaying direction from a screen area. Therefore, people located at opposite sides of the notebook computer can view simultaneously identical images, without a need to move to the side, to which the screen displays, so as to enhance convenience of communication between the parties.

### BACKGROUND OF THE INVENTION

1. Field of the Invention

The present invention relates to a notebook computer, and more particularly, to a notebook computer having projection function.

2. Description of Related Art

Along with advancement of technologies, notebook computers are as popular as the desktop computers are, due to its compact size, lightweight, and portability. In particular, central processing units used in notebook computers can perform a desirable function as well as the desktop computers. Therefore, a significant number of businessmen employ notebook computers as personal computers.

Generally speaking, a conventional notebook computer comprises a mainframe and a display. The mainframe is provided therein with electronic components including a circuit board, a processor, and so forth, for information processing and calculations; and provided at one side with a key-in device such as a keyboard. The display is pivotally connected with the mainframe, such that on the one hand, the display can be stacked on the keyboard when the notebook computer is not in use, or on the other hand, the display can be pivoted to an appropriate position or viewing angle where images are displayed.

In a business conference, when the user of a notebook computer wishes to show a specific image to another party, the other party needs to move to the same side of the notebook, as the user is, in order to view the image together from the display. It is noted that the notebook computer has a relatively small screen, and it would be inconvenient for more than one person to view the image from the screen. Therefore, there is an urge to incorporate a compact projector into a notebook computer so as to solve the problem.

### SUMMARY OF THE INVENTION

The present invention is to provide a notebook computer having projection function comprising a mainframe, a display, and a compact projector. The display is pivotally and electrically connected with the mainframe, and includes a screen area, a frame area, and a rear portion located at a backside of the screen area. The frame area surrounds the screen area. The display receives signals from the mainframe and displays corresponding images on the screen area.

The compact projector is pivotally disposed at an upper portion of the frame area, and is electrically connected with the mainframe so as to receive signals there from and to project corresponding images. The compact projector can project toward a direction opposite to a displaying direction from the screen area.

Through the above-mentioned arrangement, a user and another party can obtain identical images, despite that the user and the other party are located at opposite sides of the notebook computer. That is to say, both parties can view identical images in spite of the fact that the user views from the display and that the other party views from a projected surface so as to enhance convenience of communication between the parties.

The compact projector can be disposed on a rotating frame which is pivotally supported on the frame area of the display by a pin. The rotating frame can be additionally arranged with a web camera which is located at the same or different side from the compact projector. Alternatively, the web camera can be arranged on an independent second rotating frame. Therefore, through the web camera, documents or objects located at opposite sides of the screen area can be picked up in a digital manner and transmitted to the mainframe and then displayed on the screen area.

The notebook computer, according to the present invention, may further comprise a projecting screen movably connected with the mainframe, namely, pivotally connected with the mainframe, the rear portion of the display, or slidably disposed in a drawer underneath the mainframe, such that the projecting screen can be at an appropriate projection position.

The projecting screen may refer to a digital pad and is electrically connected with the mainframe. Therefore, the other party can use a digital pen to write and express his/her opinions or comments on the projecting screen and to display the 2D or 3D information, as expressed, on the display. As such, a mutual communication can be achieved. The projecting screen may be further provided with a clip so as to secure documents when picking up static images thereof.

The mainframe may be pivotally provided with a pivotal support underneath which can be pivoted outward from underneath the mainframe so as to support and raise the display, and to adjust view angles or to change projection distance.

In an occasion that the projecting screen is not provided, the compact projector can project images on a table or on a wall. Or if the projecting screen is provided, quality of display may be considered, for example, the projecting screen may be covered with high contrast screen materials such as metal, white cloth, or tripod screen, so as to obtain a more desirable projection image.

Other objects, advantages, and novel features of the present invention will become more apparent from the following detailed descriptions when taken in conjunction with the accompanying drawings.

### BRIEF DESCRIPTION OF THE DRAWINGS

FIG. 1 is a perspective view illustrating a notebook computer according to a first embodiment of the present invention;

FIG. 2 is a perspective view illustrating the notebook computer, as viewed from another angle, according to the first embodiment of the present invention;

FIG. 3 is a block diagram illustrating power connection for part of the components of the notebook computer according to the first embodiment of the present invention;

FIG. 4 is a schematic view illustrating a state of use of the notebook computer according to the first embodiment of the present invention;

FIG. 5 is a perspective view illustrating a notebook computer according to a second embodiment of the present invention;

FIG. 6 is a block diagram illustrating power connection for part of the components of the notebook computer according to the second embodiment of the present invention;

FIG. 7 is a perspective view illustrating a notebook computer according to a third embodiment of the present invention;

FIG. 8 is a schematic view illustrating a state of use of a notebook computer according to a fourth embodiment of the present invention; and

FIG. 9 is a perspective view illustrating part of a notebook computer according to a fifth embodiment of the present invention.

### DETAILED DESCRIPTION OF THE PREFERRED EMBODIMENTS

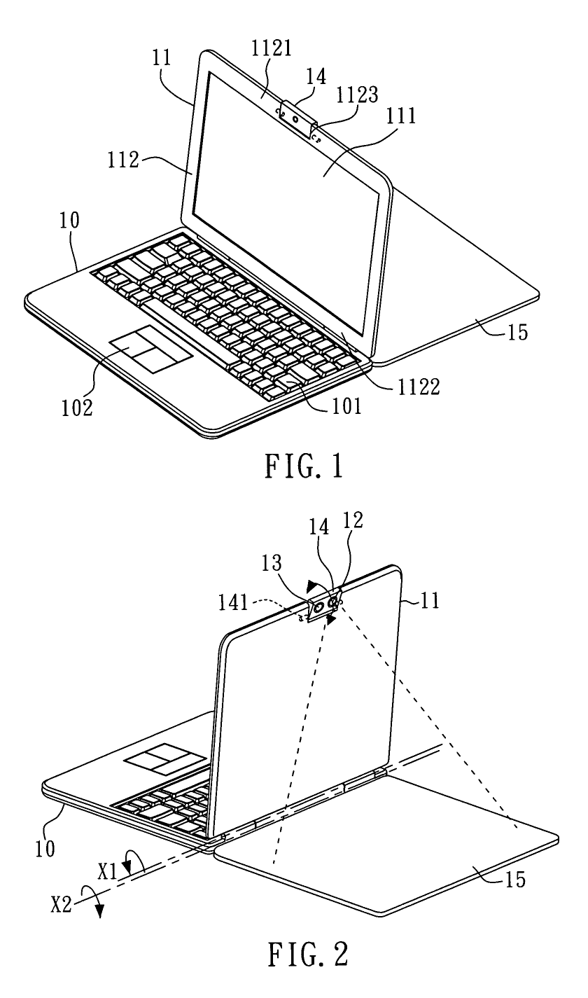

Referring to FIGS. 1 and 2, perspective views illustrating a notebook computer according to a first embodiment of the present invention, the notebook computer comprises a mainframe 10 and a display 11 which are pivotally connected with each other, wherein both the mainframe 10 and the display 11 are rectangular parallelepiped. The mainframe 10 is provided with a keyboard area 101 for keying in commands and a pointing area 102 also for key-in purpose. The display 11 includes a screen area 111 and a frame area 112 surrounding the screen area 111, wherein the screen area 111 serves to provide images to users, and the frame area 112 acts as a retaining means for a display panel and has a rectangular shape so as to conform to the display's profile. The frame area 112 includes an upper portion 1121 and a lower portion 1122 opposite to each other.

The upper portion 1121 of the frame area 112 is provided with a recess 1123, and a rotating frame 14 has a pair of pins 141 inserted into the recess 1123. Therefore, the rotating frame 14 can pivot about the pins 141.

A projecting screen 15 is also pivotally arranged on the mainframe 10 and is located at the same side where the display 11 and the mainframe 10 are pivotally connected each other. As such, the projecting screen 15 extends from bottom of the mainframe 10 and to a “projection position.” In the present embodiment, the “projection position” is where a rotation of 180 degrees is made. FIG. 2 shows that the display 11 and the projecting screen 15 correspond to rotating axes X1 and X2, respectively.

Further, the projecting screen 15 can be covered, on its projecting surface, with high contrast screen materials such as metal, white cloth, or tripod screen, so as to obtain a more desirable projecting image.

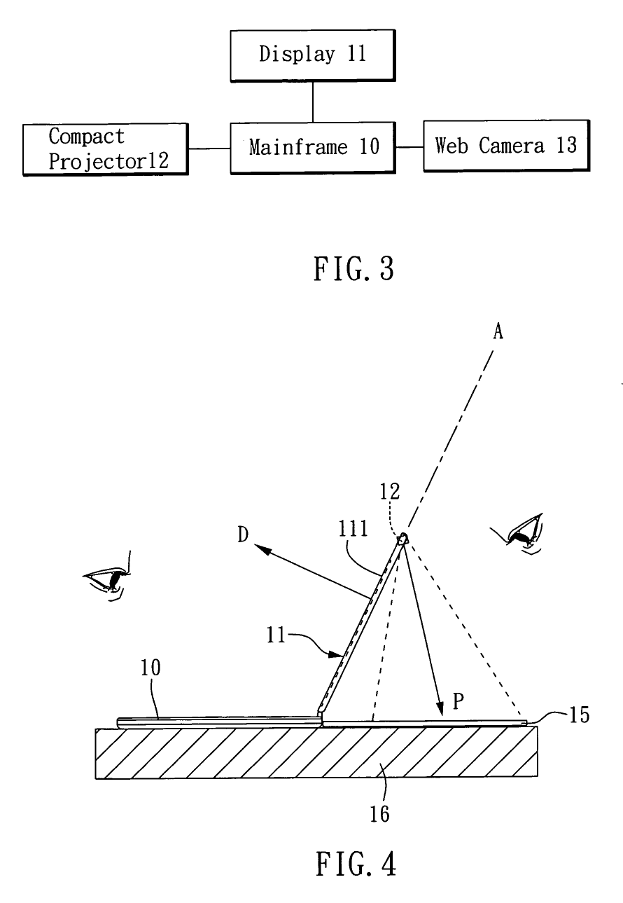

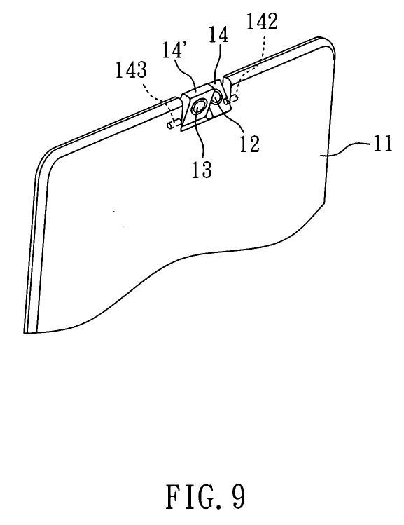

Reference may also be made to FIG. 3, a block diagram illustrating power connection for part of the components of the notebook computer according to the first embodiment of the present invention, where a compact projector 12 and a web camera 13 are supported on the rotating frame 14. In spite of the fact that, in the present embodiment, the compact projector 12 and the web camera 13 are arranged at the same side of the rotating frame 14, it is not intended for the present invention to have such limitation. In other words, the compact projector 12 and the web camera 13 can be separately disposed at different sides of the rotating frame 14; or as shown in FIG. 9, they can be separately disposed on two individual rotating frames (the rotating frame 14 and a second rotating frame 14′), such that the compact projector 12 and the web camera 13 are separately and pivotally supported by pins 142,143. Instead, the pins 142,143 can be replaced with a single pin (not shown) passing through the two rotating frames 14,14′, so that the rotating frame 14 and the second rotating frame 14′ can be pivoted coaxially and individually. The display 11, the compact projector 12, and the web camera 13 are all electrically connected with the mainframe 10 so as to receive signals of the mainframe 10 and to act their own jobs separately. That is to say, the display 11 displays corresponding images on the screen area 111, the compact projector 12 projects the corresponding images, and that the web camera 13 transmits, at real time, photographed images to the mainframe 10 for display or for storage.

Referring to FIG. 4, a schematic view illustrating a state of use of the notebook computer according to the first embodiment of the present invention, the compact projector 12 is so arranged as it projects toward a direction opposite to a displaying direction D from the screen area 111. As defined by a plane A located at the screen area 111, the displaying direction D from the screen area 111 is directed toward left of the plane A, while a projecting direction P from the compact projector 12 is directed toward right of the plane A. In other words, the projecting direction P and the displaying direction D are located oppositely against the plane A.

As shown in FIGS. 1, 2, and 4, when the display 11 and the projecting screen 15 have been pivoted out fully, the notebook computer is laid stretchingly on a table 16, i.e. the mainframe 10 and the projecting screen 15 are supported by the surface of the table 16. The screen area 111 is first adjusted to an appropriate angle so as to fit the user, and then the projecting direction P of the compact projector 12 is adjusted, through the rotating frame 14, such that images can be projected precisely on the projecting screen 15. As a result, when the user is viewing the screen area 111, another party may view the same images on the projecting screen 15 projected from the compact projector 12, without a need to share the images with the user at the same side of the notebook computer.

Further, the user may turn on the web camera 13 and turn off the compact projector 12 temporarily, such that documents or objects laid on the projecting screen 15 by the other party can be photographed and transmitted to the mainframe 10 for storage, or displayed on the screen area 111 simultaneously. Therefore, the user and the other party can avoid shifting back and forth in exchanging specific images and can photograph and store documents real time and in site.

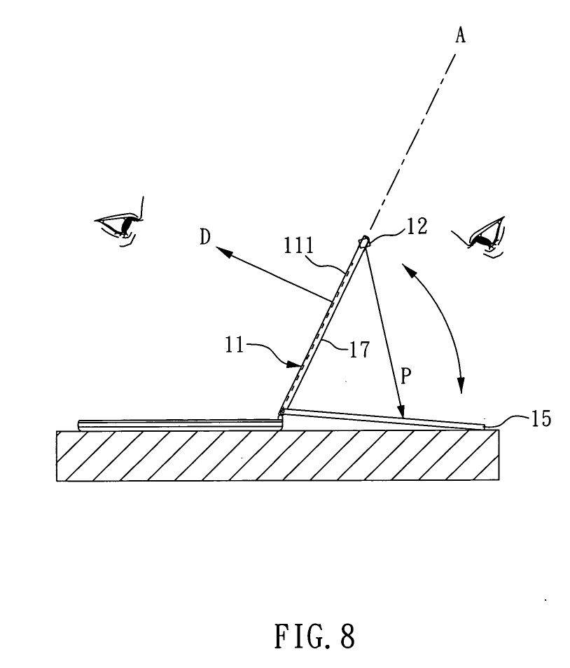

Still further, referring to FIG. 8, a schematic view illustrating a state of use of a notebook computer according to a fourth embodiment of the present invention, the projecting screen 15 can also be pivotally arranged at the lower portion of a rear portion 17 of the display 11 (located at a backside of the screen area 111). When the projecting screen 15 is not in use, it can be folded and attached to the rear portion 17, act as a back casing for the notebook computer and protects the notebook computer. Or when the projecting screen 15 is in use, it can be unfolded and laid down, such that the projecting screen 15 can be pivoted out to a certain projection position.

The projecting screen 15 can be pivoted and reach to a certain angled position which is not limited to that mentioned above, or rather the angled position can be determined as actually required. Besides, the pivotability of the compact projector 12 can be employed so as to meet the user's demand, such that the images can be projected on a table or on a wall.

Given the above, it is understood that when using a notebook computer for discussion, the present invention can provide more convenience on information sharing, so that the other party does not need to be crowded with the user in viewing the images. And through a web camera attached to the notebook computer, the user can readily acquire or store the information provided by the other party without shifting to the other party's position. Obviously, the present invention significantly raises practicability of the notebook computer.

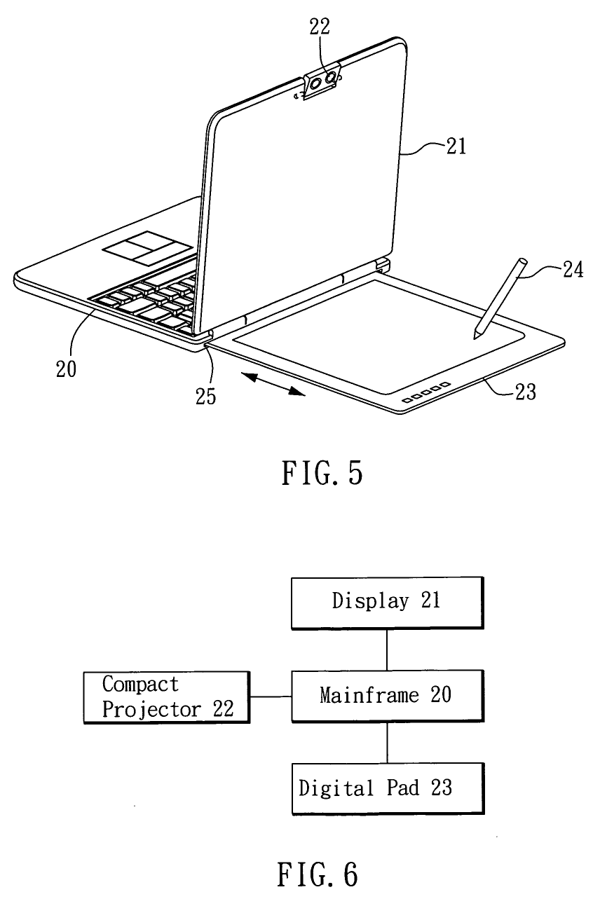

Now referring to FIG. 5, a perspective view illustrating a notebook computer according to a second embodiment of the present invention, and to FIG. 6, a block diagram illustrating power connection for part of the components of the notebook computer, a compact projector 22 is pivotally arranged on a display 21, and a projecting screen 23 is slidably disposed in a drawer 25 underneath a mainframe 20. The projecting screen 23 can be withdrawn from a receiving position underneath the mainframe 20 for image projection by the compact projector 22. In the present embodiment, the projecting screen 23 refers to a digital pad and is electrically connected with the mainframe 20.

Therefore, not only the user can employ the compact projector 22 to project images, which are displayed on the display 21, on the projecting screen 23, but also the other party can use a digital pen 24 to write and input his/her expressions on the projecting screen 23 so as to transmit the information, as expressed, from the digital pad to the mainframe 20 and then the information is displayed on the display 21. As such, a more desirable effect of mutual communication can be achieved.

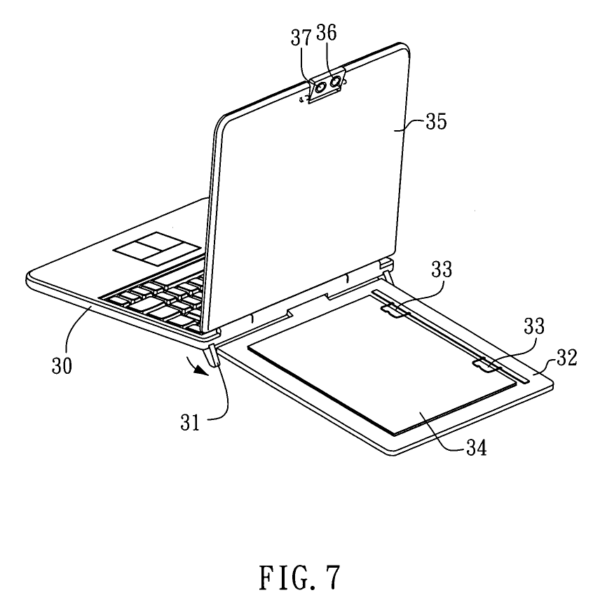

Referring to FIG. 7, a perspective view illustrating a notebook computer according to a third embodiment of the present invention, a projecting screen 32 is pivotally arranged on a mainframe 30. A display 35 is provided, integrally, with a compact projector 36 and a web camera 37. A pivotal support 31 is received in and underneath the mainframe 30 and can be pivoted out from underneath the mainframe 30 so as to support and raise the display 35. The projecting screen 32 is provided thereon two clips 33.

According to the above-mentioned arrangement, the display 35 can be raised so as to make the projecting screen 32 a greater view angle and to increase a distance for projection between the compact projector 36 and the projecting screen 32. On the other hand, when the other party's document 34 is to be photographed, the document 34 can be secured on the projecting screen 32 by the clips 33, such that the document 34 can be readily positioned for photograph taking.

Although the present invention has been explained in relation to its preferred embodiments, it is to be understood that many other possible modifications and variations can be made without departing from the scope of the invention as hereinafter claimed.

What is claimed is:

1. A notebook computer having projection function, comprising:
a mainframe;
a display, being pivotally and electrically connected with the mainframe, and including a screen area, a frame area, and a rear portion located at a backside of the screen area, wherein the frame area surrounds the screen area, and the display receives signals from the mainframe and displays corresponding images on the screen area; and
a compact projector, being pivotally disposed at an upper portion of the frame area, and being electrically connected with the mainframe so as to receive signals therefrom and to project the corresponding images.

2. The notebook computer having projection function as claimed in claim 1, further comprising a projecting screen pivotally connected with the mainframe.

3. The notebook computer having projection function as claimed in claim 1, further comprising a projecting screen pivotally connected with the rear portion of the display.

4. The notebook computer having projection function as claimed in claim 1, further comprising a projecting screen slidably disposed in a drawer underneath the mainframe, such that the projecting screen can reach to an appropriate projection position.

5. The notebook computer having projection function as claimed in claim 1, wherein the compact projector is disposed on a rotating frame which is pivotally supported on the frame area of the display by a pin.

6. The notebook computer having projection function as claimed in claim 5, further comprising a web camera disposed on the rotating frame.

7. The notebook computer having projection function as claimed in claim 5, further comprising a web camera disposed on a second rotating frame which is pivotally supported on the frame area of the display by another pin.

8. The notebook computer having projection function as claimed in claim 2, wherein the compact projector is disposed on a rotating frame which is pivotally supported on the frame area of the display by a pin.

9. The notebook computer having projection function as claimed in claim 8, further comprising a web camera disposed on the rotating frame.

10. The notebook computer having projection function as claimed in claim 8, further comprising a web camera disposed on a second rotating frame which is pivotally supported on the frame area of the display by another pin.

11. The notebook computer having projection function as claimed in claim 3, wherein the compact projector is disposed on a rotating frame which is pivotally supported on the frame area of the display by a pin.

12. The notebook computer having projection function as claimed in claim 11, further comprising a web camera disposed on the rotating frame.

13. The notebook computer having projection function as claimed in claim 11, further comprising a web camera disposed on a second rotating frame which is pivotally supported on the frame area of the display by another pin.

14. The notebook computer having projection function as claimed in claim 4, wherein the compact projector is disposed on a rotating frame which is pivotally supported on the frame area of the display by a pin.

15. The notebook computer having projection function as claimed in claim 14, further comprising a web camera disposed on the rotating frame.

16. The notebook computer having projection function as claimed in claim 14, further comprising a web camera disposed on a second rotating frame which is pivotally supported on the frame area of the display by another pin.

17. The notebook computer having projection function as claimed in claim 2, wherein the projecting screen is a digital pad electrically connected with the mainframe.

18. The notebook computer having projection function as claimed in claim 3, wherein the projecting screen is a digital pad electrically connected with the mainframe.

19. The notebook computer having projection function as claimed in claim 4, wherein the projecting screen is a digital pad electrically connected with the mainframe.

20. The notebook computer having projection function as claimed in claim 2, wherein the projecting screen is provided with a clip.

21. The notebook computer having projection function as claimed in claim 3, wherein the projecting plate is provided with a clip.

22. The notebook computer having projection function as claimed in claim 4, wherein the projecting plate is provided with a clip.

23. The notebook computer having projection function as claimed in claim 2, wherein the projecting screen is covered with metal, white cloth, or tripod screen.

24. The notebook computer having projection function as claimed in claim 3, wherein the projecting screen is covered with metal, white cloth, or tripod screen.

25. The notebook computer having projection function as claimed in claim 4, wherein the projecting screen is covered with metal, white cloth, or tripod screen.

26. The notebook computer having projection function as claimed in claim 2, wherein the mainframe is pivotally provided underneath a pivotal support which is pivoted outward from underneath the mainframe so as to support and raise the display.

27. The notebook computer having projection function as claimed in claim 3, wherein the mainframe is pivotally provided underneath a pivotal support which is pivoted outward from underneath the mainframe so as to support and raise the display.

28. The notebook computer having projection function as claimed in claim 4, wherein the mainframe is pivotally provided underneath a pivotal support which is pivoted outward from underneath the mainframe so as to support and raise the display.
